(19) United States
(12) Patent Application Publication
(10) Pub. No.: US 2026/0187747 A1
(43) Pub. Date: Jul. 2, 2026

(54) IDENTITY AUTHENTICATION IN AN AGENTIC ARCHITECTURE

(71) Applicant: American Express Travel Related Services Company, Inc., New York, NY (US)

(72) Inventor: Andras L. FERENCZI, Scottsdale, AZ (US)

(73) Assignee: American Express Travel Related Services Company, Inc., New York, NY (US)

(21) Appl. No.: 19/006,919

(22) Filed: Dec. 31, 2024

(51) Int. Cl. G06T 1/00

(52) U.S. Cl. CPC G06T 1/0071

(57) ABSTRACT

A computing device (e.g., a cloud-based device, an Identity-as-a-Service (IDaaS) server, an identity management device, etc.) may extract an embedded first watermark from content received from a first agent device in a first format as part of an agentic workflow. The content in the first format may be authenticated based on an identifier of the first agent device mapped to the first watermark. Upon authenticating the the first agent device, the computing device may identify a second agent device in the agentic workflow to send at least a portion of the content transformed into a second format and embedded with a second watermark. The computing device may block a request from the second agent device to send at least the portion of the content transformed into the second format to a third agent device based on a discrepency between the second watermark and an identifier of the second agent device.

### BACKGROUND

In agentic systems involving collaborative multimedia content processing, ensuring the authenticity of agents exchanging data and maintaining a verifiable chain of custody of the data is critical. Traditional authentication methods often struggle with untrusted environments where agents may be compromised or data manipulated. Existing agentic systems usually rely on token-based authentication and metadata tracking, susceptible to tampering or loss during format transformations. As exchanged data undergoes format changes, traditional systems struggle to verify the authenticity of agents and preserve data provenance throughout its lifecycle.

### SUMMARY

A centralized computing device (e.g., a cloud-based device, an Identity-as-a-Service (IDaaS) server, an identity management device, etc.) implemented within a decentralized agentic architecture may extract an embedded first watermark from content received from a first agent device in a first format as part of an agentic workflow within the agentic architecture. As data is communication between agents during the workflow, each agent interacts with the centralized computing device to extract and verify the watermark for the purposing of validating data provenance at each stage of the workflow. The content in the first format may be authenticated based on an identifier of the first agent device mapped to the first watermark. Upon authenticating the first agent device, the computing device may identify a second agent device in the agentic workflow to send at least a portion of the content transformed into a second format and embedded with a second watermark. The computing device may block a request from the second agent device to send at least the portion of the content transformed into the second format to a third agent device based on a discrepency between the second watermark and an identifier of the second agent device.

### BRIEF DESCRIPTION OF THE DRAWINGS

The accompanying drawings are incorporated herein and form a part of the specification.

FIG. 1 shows a block diagram of an example system for identity authentication in an agentic architecture, according to some aspects of this disclosure.

FIG. 2 shows an example communication diagram for an example system for identity authentication in an agentic architecture, according to some aspects of this disclosure.

FIG. 3 shows a flowchart of an example method for identity authentication in an agentic architecture, according to some aspects of this disclosure.

FIG. 4 shows an example computer system useful for implementing various aspects of this disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for identity authentication in an agentic architecture. According to some aspects of this disclosure, a computing device (e.g., a cloud-based device, an Identity-as-a-Service (IDaaS) server, an identity management device, etc.) may be implemented in an agentic architecture to verify the authenticity of agent devices (e.g., artificial intelligence (AI) agents, etc.) and ensure data provenance.

For purposes of this disclosure, an agentic architecture refers a network topology that enables autonomous software programs (i.e., agents)—often running on edge or endpoint devices—to interact, negotiate, and initiate transactions with minimal centralized orchestration. Unlike conventional networks that primarily rely on static client-server models and centralized intermediaries, a network agentic architecture leverages specialized hardware and low-latency communication layers to facilitate more interactions among distributed agents. For purposes of this disclosure, an agentic workflow may include any process where multiple agents (e.g., agent devices, etc.) work collaboratively and independently to achieve tasks or goals. The agents may operate with decision-making capabilities and may dynamically interact with one another, respond to changes, and make progress toward objectives without requiring constant oversight or direct intervention.

An an agentic architecture supporting multiple agents can present security challenges due to the decentralized nature of the communications and the autonomy in decision making given to agents. Elements of this disclosure provide a technical improvement to communications within an agentic architecture by providing enhanced identity authentication of actors (users, agents) that transact within the architecture.

According to some aspects of this disclosure, as agents exchange content (e.g., multimedia content, etc.), for example, as part of an agentic workflow, a unique watermark (e.g., an invisible watermark, a perceptible watermark, etc.) may be embedded within the content. According to some aspects of this disclosure, the watermark may embedded by the centralized computing device. Alternatively, the watermark may be embedded by agents and verified by a centralized computing device. The watermark may be decoded by the centralized computing device at each stage of the agentic workflow to guarantee data provenence and/or verify the authenticity of the communicating agent device. The computing device may facilitate re-embedding the token into the content when it undergoes format transformations, ensuring the chain of custody is preserved and facilitating traceability of the data when even the data undergoes any transformations.

For example, a hotel may have an agentic architecture designed to streamline a check-in process. The agentic archicture can include various agents and a computing device that performs verification. As a guest enters the hotel, a camera (Agent A) captures an image of the guest. Agent A may embed a watermark into the image and send it along with a unique token identifying Agent A to a computing device (e.g., a cloud-based device, an Identity-as-a-Service (IDaaS) server, an identity management device, etc.) for verification. Agent A may also include features for identifying the guest, such as through image recognition, and may transmit the identification with the image. The computing device may decode the token to verify the identity of Agent A and extract the watermark to ascertain the provenance of the data (e.g., the image of the guest, an identification of the guest, etc.) received from Agent A. According to some aspects of this disclosure, the token and the watermark may be one and the same, where the watermark serves as the unique token. Alternatively, the token and the watermark may be separate security elements.

Upon successful verification, the centralized computing device may forward the guest’s information to the hotel’s check-in system (Agent B), which manages reservations and payment arrangements. Agent B may capture data indicative of reservation and payment information for the guest. Agent B embeds a version of the watermark, modified for the format of the data indicative of the reservation and the payment information into the data and sends it along with a unique token identifying Agent B to the computing device for verification. Again, the computing device may decode the token to verify the identity of Agent B and extract the watermark to verify the provenance of the data. Upon successful verification, the computing device may forward guest preferences to an in-room control system (Agent C), which adjusts settings such as temperature and TV channels. Throughout the process, the centralized computing device may ensure that each agent interaction is authenticated and that the integrity of data (in any format) is maintained via the embedded watermarks. The centralized computing device may store information indicative of each process step to provide a traceable history for security, audit, and/or the like. Again, this is merely an example, and any other examples may be applicable for identity authentication in an agentic architecture as described herein.

In another example, within a merchant facility, multiple agent devices may operate collaboratively to capture and process data while embedding watermarks to ensure traceability and security throughout the checkout process. A first agent (Agent 1) , may be an entrance camera that captures an image of a user upon entry to identify them and initiate their session. Agent 1 may embeds a watermark containing its unique ID, the timestamp, and a session identifier. For example, the watermark may be embedded in the image metadata, as a steganographic overlay, and/or the like. The watermarked data may be sent to a computing device (e.g., a cloud-based device, an Identity-as-a-Service (IDaaS) server, an identity management device, etc.) for user identity verification. Once validated, the computing device may enhance the watermark with cryptographic information and forward it to the next agent (Agent 2) in the workflow.

Agent 2 may be a shelf camera and/or the like positioned within the merchant facility to capture images of the user interacting with items. Interaction with items may include, but is not limited to, picking up an item, viewing the item (e.g., identified via eye tracking, etc.), and/or the like. Agent 2 may embed a new watermark containing its ID, the user’s session identifier, item information (e.g., barcode), and an event timestamp. According to some aspects of this disclosure, the watermark may be applied directly to the image or encoded with metadata and sent to the computing device for verification. The computing device may ensure that the interaction is legitimate, update the user session with the selected items, and enhance the watermark before passing it along to another agent (Agent 3).

Agent 3 may be a checkout terminal camera that captures the user’s image, the selected items, and the payment action at the point of sale. Agent 3 may embed a watermark that includes its ID, a verified list of items, anonymized payment token data, and a transaction timestamp. The watermarked data may be sent to the computing device, and the computing device may validate the user’s identity, the items selected, and the payment details to ensure consistency across all stages of the agentic workflow. The computing device may sends the verified data to an agent (Agent 4) operating the backend of the merchant facility for receipt generation and order confirmation. Each agent’s watermarking and validation by computing device may ensure traceability and data integrity while maintaining privacy and security to enable a seamless and secure experience. Again, this is merely another example of an agentic workflow as described herein.

As another example, a centralized computing device (e.g., a cloud-based device, an Identity-as-a-Service (IDaaS) server, an identity management device, etc.) may extract an embedded first watermark from content received from a first agent device in a first format as part of an agentic workflow. The content in the first format may be authenticated based on an identifier of the first agent device mapped to the first watermark. Upon authenticating the the first agent device, the computing device may identify a second agent device in the agentic workflow to send at least a portion of the content transformed into a second format and embedded with a second watermark. The computing device may block a request from the second agent device to send at least the portion of the content transformed into the second format to a third agent device based on a discrepancy between the second watermark and an identifier of the second agent device. By implementing a mechanism where discrepencies in watermarks and/or expected unique tokens to block unauthenticated content, the system, apparatus, device, method and/or computer program product embodiments, and/or combinations and sub-combinations thereof, for identity authentication in an agentic architecture, as decribed herein, may prevent fraud and enhance security and data integrity. These and other advantages are described herein.

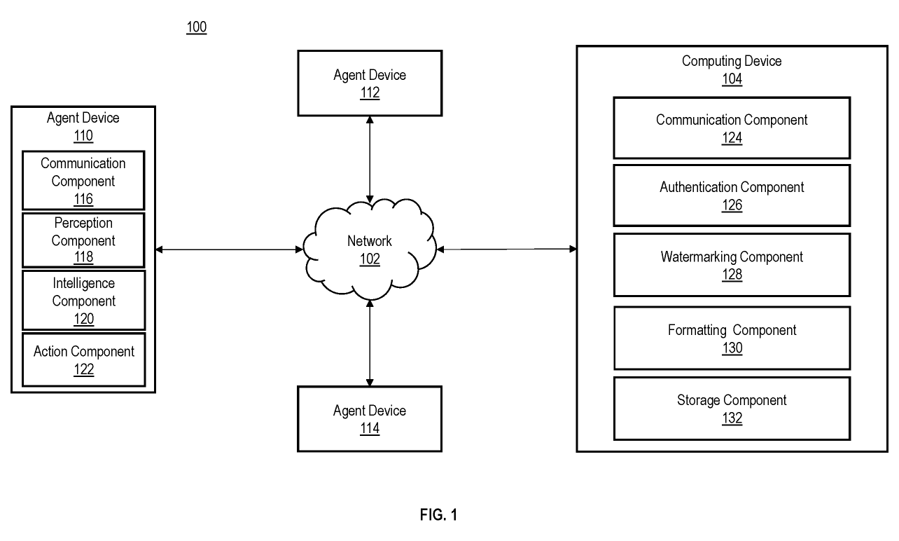

FIG. 1 shows an example system 100 for identity authentication in an agentic architecture. System 100 is merely an example of one suitable system environment and is not intended to suggest any limitation as to the scope of use or functionality of aspects described herein. System 100 should not be interpreted as having any dependency or requirement related to any single component or combination of components described therein.

According to some aspects of this disclosure, system 100 may include a network 102. Network 102 may include a packet-switched network (e.g., internet protocol-based network), a non-packet-switched network (e.g., quadrature amplitude modulation-based network), and/or the like. Network 102 may include network adapters, switches, routers, modems, and the like connected through wireless links (e.g., radiofrequency, satellite) and/or physical links (e.g., fiber optic cable, coaxial cable, Ethernet cable, or a combination thereof). Network 102 may include public networks, private networks, wide area networks (e.g., Internet), local area networks, and/or the like. Network 102 may include a payment network and/or may support/facilitate financial transactions. Network 102 may provide and/or support communication from a telephone, cellular phone, modem, and/or other electronic devices to and throughout the system 100. For example, system 100 may include and support communications between agent device 110, agent device 112, agent device 114, and computing device 104 via network 102.

According to some aspects of this disclosure, agent device 110, agent device 112, and agent device 114 may be any devices (e.g., sensor devices, Internet-of-Things (IoT) devices, point-of-sale (POS) devices, network devices, computing devices, etc.) that operate autonomously and/or semi-autonomously in response to specific tasks, requests, environmental conditions, and/or the like. According to some aspects of this disclosure, agent device 110, agent device 112, and agent device 114 may be implemented as part of a collaborative and/or distributed system where each agent device generates and/or manages various forms of content (e.g., multimedia content, etc.) in relation or in response to specific tasks, requests, environmental conditions, and/or the like.

According to some aspects of this disclosure, agent device 110, agent device 112, and agent device 114 may each include computational, sensory, and communication capabilities to perceive surroundings, make decisions, and execute actions. For example, agent device 110 may include a communication component 116, a perception component 118, an intelligence component 120, and an action component 122. FIG. 1 depicts agent device 110 in greater detail than agent device 112 and agent device 114. However, agent device 112 and agent device 114 may each include similar configurations (e.g., communication components, perception components, intelligence components, action components) as described herein for agent device 110.

According to some aspects of this disclosure, agent device 110 may include a communication component 116. Communication component 116 may facilitate and/or enable communication with network 102 (e.g., devices, components, and/or systems of network 102, etc.), agent device 112, agent device 114, computing device 104, and/or any other device/component of system 100. For example, communication component 116 may include hardware and/or software to facilitate communication. According to some aspects of this disclosure, communication component 116 may include one or more of a modem, transceiver (e.g., wireless transceiver, etc.), digital-to-analog converter, analog-to-digital converter, encoder, decoder, modulator, demodulator, tuner (e.g., QAM tuner, QPSK tuner), and/or the like. Communication component 116 may decode incoming data, extract actionable content, and send feedback or status updates to devices, users, and/or components of system 100. According to some aspects of this disclosure, communication component 116 may include any hardware and/or software necessary to facilitate communication.

According to some aspects of this disclosure, agent device 110 may include perception component 118. Perception component 118 may manage input for agent device 110. Perception component 118 may receives data from input components including, but not limited to, sensors, cameras, microphones, tactile sensors, digital data sources, user interfaces, and/or the like to gather raw environmental data. Perception component 118 may perform data preprocessing of raw input data, normalizing and filtering the raw input data for further analysis.

According to some aspects of this disclosure, perception component 118 may utilize one or more feature extraction algorithms to identify relevant characteristics from input data. Perception component 118 may combine data from multiple sensors, for example, via sensor fusion techniques and/or the like, to develop a coherent understanding of the environment. For example, perception component 118 may employ computer vision, natural language processing, and/or machine learning to detect objects, interpret distances, identify patterns, and/or otherwise process inputs to form the basis for situational awareness of agent device 110.

According to some aspects of this disclosure, agent device 110 may include intelligence component 120. Intelligence component 120 may manage decision-making for agentic device 110. Intelligence component 120 may process and analyze structured data including, but not limited to, customer information, financial data, sensor readings, and/or the like. For example, agent device 110 may be implemented in a financial workflow and intelligence component 120 may perform predictive analysis, automated transactions/trading, analysis of market trends, execution of investment decisions, and/or the like. Intelligence component 120 may identify salient data points to facilitate risk management, fraud detection, and customer relationship management (CRM). Intelligence component 120 may support any agentic workflow. Intelligence component 120 may define objectives and target outcomes for agent device 110. Intelligence component 120 may generate strategies and plans to achieve defined goals with consideration for the functionality of agent device 110 and/or environmental constraints.

Intelligence component 120 may receive processed data/information from perception component 118 and employ rule-based systems, large language models (LLMs), vector stores, machine-learning algorithms, and/or neural networks to analyze the data/information and determine an optimal course of action. For example, LLMs may be used to generate human-quality text, translate languages, and answer questions. Vector stores may be used to store and retrieve vectors representing data points, enabling efficient similarity searches and recommendations. One or more graph databases may represent and analyze complex relationships and networks.

Intelligence component 120 may evaluate options and execute logical decisions, and may include a memory/storage system that stores past states, learned behaviors, and/or situational data to improve future performance. Prediction mechanisms including, but not limited to, machine-learning mechanisms (e.g., supervised learning, unsupervised learning, reinforcement learning, etc.), statistical models (e.g., regression analysis, Bayesian inference, Markov models, etc.), probabilistic models, descision trees, random forest analysis, fuzzy inference, time-series analysis (e.g., autoregressive integrated moving average (ARIMA), Kalman filters, etc.), neural networks (e.g., convolutional neural networks, recurrent neural networks, transformer models, etc.), and/or the like enable intelligence component 120 to anticipate potential outcomes and enable agent device 110 to adapt to dynamic environments.

According to some aspects of this disclosure, agent device 110 may include action component 122. Action component 122 may translate decisions made by intelligence component 120 into physical and/or digital actions. Action component 122 may interface with actuators of agent device 110, including, but not limited to, motors/servos, displays, network components/interfaces, ML models, LLM models, video components, audio components, and/or the like to perform specific tasks. For example, action component 122 may use signal controllers to convert digital commands into electrical signals, prompts, commands, and/or the like. According to some aspects of this disclosure, action component 122 may include one or more execution monitors to ensure actions are performed accurately and provide feedback to intelligence component 120 for validation.

According to some aspects of this disclosure, communication component 116, perception component 118, intelligence component 120, and action component 122 may operate intergrated to enable agentic device 110 to function autonomously and/or semi-autonomously. Perception component 118 may sense and interpret any environment; intelligence component 120 may use the senses and interpretations of perception component 118 to make informed decisions, action component may execute the decisions of intelligence component 120, and communication component 116 may facilitate interaction with external agent devices and/or devices/components of system 100.

According to some aspects of this disclosure, computing device 104 may be and/or include a cloud-based device, an Identity-as-a-Service (IDaaS) server, an identity management device, and/or the like. Computing device 104 may be a centralized computing device in a decentralized agentic architecture. Decentralized agent devices can offload tasks such as identity verification and credential management computing device 104, allowing the agent devices to focus on their primary functions (e.g., environmental data capture, financial operations, content delivery, etc.).

As a centralized computing device, computing device 104 may operate as a single point of data and agent device verification to reduce the risk of inconsistent or insecure authentication mechanisms across decentralized agent devices (e.g., agent device 110, agent device 112, and agent device 114, etc.). Computing device104 may incorporate measures including, but not limited to, multi-factor authentication, biometrics, and encryption, to secure data communicated by agent devices (e.g., agent device 110, agent device 112, and agent device 114, etc.) within system 100. For example, computing device 104 may orchestrate embedding, extraction, verification, and re-embedding of watermarks within content (e.g., multimedia content, etc.) exchanged by of agent devices 110, 112, and 114 to ensure secure data authentication and provenance.

As agent devices 110, 112, and 114 exchange content (e.g., multimedia content, etc.), for example, as part of an agentic workflow (e.g., a series of tasks that artificial intelligence agents, such as agent devices 110, 112, and 114, perform in a structured sequence to complete a goal, business process, etc.), a unique watermark (e.g., an invisible watermark, a perceptible watermark, etc.) may be embedded (e.g., via operations including metadata generation, hashing, steganography, etc.) within the content. To embed the watermark in the content, computing device104 may act/operate as a proxy or intermediary between agent devices 110, 112, and 114. Before agent devices (e.g., agent device 110, agent device 112, and agent device 114, etc.) send/pass content to a next agent device, computing device 104 may intercept the content and generate a unique watermark for the content and/or data exchange. According to some aspects of this disclosure, the watermark may be unique to a agent device and may include an identifier (e.g., an agent identifier, a device identifier, a cryptographic token, etc.) of an agent device. According to some aspects of this disclosure, the watermark may alos or alternatively be unique to the content of an agentic workflow and may include timestamps, session identifers, workflow transaction identifers, and/or the like. The watermark may be decoded by computing device 104 at each stage of the agentic workflow to verify provenence of communicated content and/or the authenticity of the sender (e.g., agent device, etc.). Computing device 104 may facilitate re-embedding the watermark into the content when it undergoes format transformations, ensuring the chain of custody is preserved.

According to some aspects of this disclosure, computing device 104 may include a communication component 124. Communication component 124 may facilitate and/or enable communication with network 102 (e.g., devices, components, and/or systems of network 102, etc.), agent device 110, agent device 112, agent device 114, and/or any other device/component of system 100. For example, communication component 124 may include hardware and/or software to facilitate communication. According to some aspects of this disclosure, communication component 124 may include one or more of a modem, transceiver (e.g., wireless transceiver, etc.), digital-to-analog converter, analog-to-digital converter, encoder, decoder, modulator, demodulator, tuner (e.g., QAM tuner, QPSK tuner), and/or the like. Communication component 124 may decode incoming data, extract actionable content, and send feedback or status updates to devices, users, and/or components of system 100. According to some aspects of this disclosure, communication component 124 may include any hardware and/or software necessary to facilitate communication.

According to some aspects of this disclosure, computing device 110 may include an authentication component 126. Authentication component 126 may operate to verify the identities of agent devices 110, 112, and 114 as they exchange data/information across system 100. Authentication component 126 may ensure that only authorized entities can access or process data/information, such as multimedia content and/or the like across system 100. Authentication component 126 may manage user credentials and support utilities such as multi-factor authentication (MFA) to enhance security. For example, computing device 110 may assign agent devices 110, 112, and 114, each unique credentials, including, but not limited to, digital certificates, cryptographic keys, and/or the like. When either of agent devices 110, 112, and 114 attempt to communicate with computing device 104, the agent devices may present computing device 104 with the assigned credential and authentication component 126 may verify the credentials against a registry and/or look up table for authorized devices.

According to some aspects of this disclosure, to enhance security, authentication component 126 may implement multi-factor authentication (MFA), requiring agent devices 110, 112, and 114 to provide multiple forms of verification. For instance, in certain scenarios, in addition to presenting digital certificates, agent devices 110, 112, and 114 (and/or users of system 100) may also be required to authenticate through a secure token or a biometric verification process. According to some aspects of this disclosure, authentication component 126 may analyze specific attributes of agent devices 110, 112, and 114, including, but not limited to, hardware configurations, operating system versions, network parameters, and/or the like to create a unique device fingerprint. By comparing this fingerprint to known profiles, authentication component 126 may identify anomalies that may indicate unauthorized devices attempting to gain access to an agentic workflow and/or related data/information.

According to some aspects of this disclosure, in response to a successful initial authentication of agent devices 110, 112, and 114, authentication component 126 may generate and issue a time-limited access token to agent devices 110, 112, and 114. The generated token may need to be presented in subsequent communications, streamlining the authentication process while maintaining security. Authentication component 126 may ensure that only devices with valid credentials can initiate interactions. According to some aspects of this disclosure, authentication component 126 may execute ongoing assessments of the behavior and context during interactions with agent devices 110, 112, and 114. Authentication component 126 may monitor data indicative of factors including, but not limited to, communication patterns, geolocation, and/or the like. Computing device 104, for example, using authentication component 126, may detect and respond to suspicious activities in real time to ensure the security and trustworthiness of agent devices 110, 112, and 114 throughout communication sessions.

According to some aspects of this disclosure, authorization tokens may be used in conjunction with other authentication methods, for example, watermarking and/or the like, to provide a secure and efficient means of verifying the identity of agent devices 110, 112, and 114. According to some aspects of this disclosure, computing device 110 may include a watermarking component 128. Watermarking component 126 may convert authorization tokens into a digital watermark that may be embedded in content. The watermark may be generated and embedded according to the type of content.

For example, embedding watermarks in image data, watermarking component 126 may use spatial domain techniques including, but not limited to, Least Significant Bit (LSB) modification, Arnold transform, watermark casting algorithms, Singular Value Decomposition (SVD) based embedding, spread spectrum embedding, and/or the like to directly modify pixel values to embed a watermark. For example, using the Least Significant Bit (LSB) method, watermarking component 126 may alter the least significant bits of selected pixels in image data to encode a watermark. According to some aspects of this disclosure, watermarking component 126 may use frequency domain techniques including, but not limited to, Discrete Cosine Transform (DCT), Discrete Wavelet Transform (DWT), and/or the like to transform image data into a frequency domain. When image data is transformed to the frequency domain, watermarking component 126 may then embed a watermark by modifying the coefficients in the transformed domain.

According to some aspects of this disclosure, to embed watermarks into text data, watermarking component 126 may usesyntactic analysis to introduce subtle changes in the the structure of text. For example watermarking component 126 may alter punctuation or rephrase sentences, without changing the overall meaning. Watermarking component 126 may use semantic analysis to modify text data by using synonyms or altering sentence structures to embed the watermark.

According to some aspects of this disclosure, to embed watermarks into audio data, watermarking component 126 may usetime domain analysis. For example, watermarking component 126 may embed a watermark by directly modifying the amplitude of an audio signal amplitude in specific time intervals.According to some aspects of this disclosure, watermarking component 126 may usefrequency Domain techniques where transformations like Fast Fourier Transform (FFT) and/or the like are used to embed a watermark in specific frequency bands.

To ensure the integrity and authenticity of multimedia content, watermarks embedded in different media types by watermarking component 126 may may be linked through a unified unique identifier of associated agent devices to enable cross-referencing and verification across various portions of the content. As such an initial identifier (e.g., authentication token, an identifier of an agent device, etc.) may serves as a watermark, modified accordingly, and embedded across all related media types.

In an example scenario, when an initial request arrives, computing device 104, using authentication component 126 etc., verifies the authenticity of the sender (e.g., agent devices 112, 114, 116, etc.) by decoding the embedded watermark within the provided multimedia content. This verification confirms the identity associated with the unique token embedded in the data, ensuring that only authorized agent devices can proceed with further processing. As the data traverses through a chain of collaborating agents (e.g., agent devices 112, 114, 116, etc.), each agent (e.g., agent devices 112, 114, 116, etc.) interacts with computing device 104 to extract and verify the watermark, guaranteeing data provenance at every stage. If an agent (e.g., agent devices 112, 114, 116, etc.) needs to convert the data into a different format (e.g., from image to text), it requests computing device 104 to reembed the same token within the transformed content, preserving the chain of custody. This ensures seamless traceability even when data undergoes transformations. By maintaining a secure and verifiable link between the original sender and the final recipient, the system, apparatus, device, method and/or computer program product embodiments, and/or combinations and sub-combinations thereof, for identity authentication in an agentic architecture improves at least the technological fields of data management (e.g., digital media and content protection, etc.) and fraud prevention by providing enhanced security, data integrity, and granular access control for data.

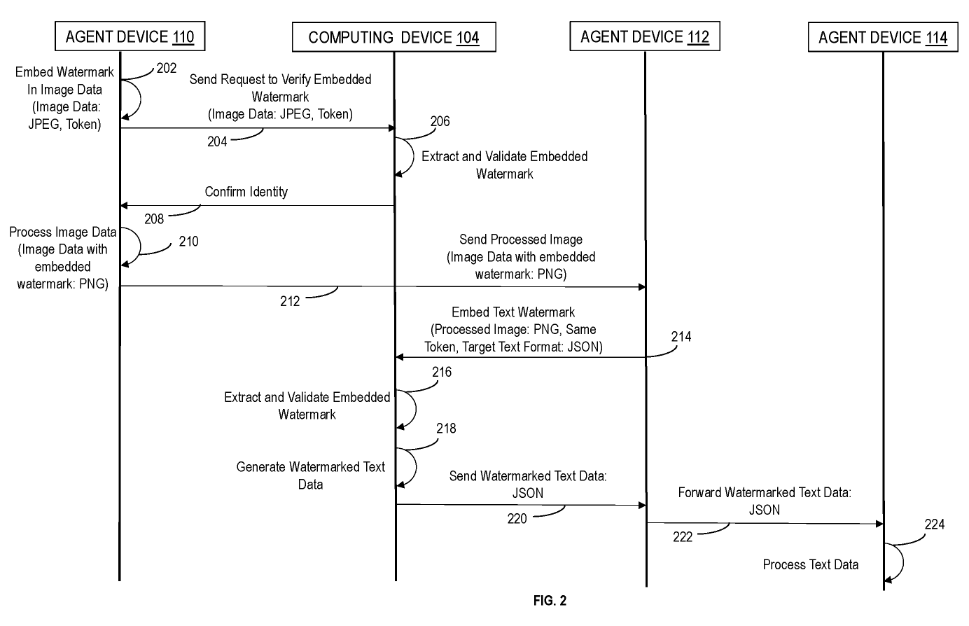

FIG. 2 is a flowchart for an example method 200 for identity authentication in an agentic architecture, according to aspects of this disclosure. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously or in a different order than shown in FIG. 2, as will be understood by a person of ordinary skill in the art. Method 200 shall be described with reference to FIG. 1. However, method 200 is not limited to FIG. 1 or related aspects.

In an example scenario, a merchant system may have an agentic architecture designed to item purchase process. In 202, agent device 110 may embed a watermark in captured environmental information. For example, the environmental information may be captured as a user navigates a mechant facility and/or the like. The environmental information may include information used to identify the user and/or validate the provenance of the environmental data. For example, the environmental information may include an idenfier of agent device 110, a timestamp to record the time of capture, a session identifier to link the user to a user session (e.g., a shopping experience/session, etc.), and/or the like.

According to some aspects of this disclosure, at least a portion of the environmental information may be in a first format. For example, the first format of the environmental information may be image data (e.g., JPEG format, etc.). The watermark may be in a format corresponding to the image data. The image data may be an initial input to an agentic workflow, such that, in response to capturing the image data, agent device 110 may need to ultimately send the processed image data to another agent (e.g., agent device 112, etc.) for further processing.

In 204, agent device 110 may send the environmental information to computing device 104, requesting verification of an embedded watermark within the environmental information.For example, verification of an embedded watermark within the environmental information may be used to indicate that the user has initiated the aagentic workflow, verify the agent device 110, validate the provenance of the environmental data, and/or provide insight associated with any other data information associated with the agentic workflow.

In 206, computing device 104 may identify the embedded watermark and maps the watermark to an identifier (e.g., token, etc.) of agent device 110 to verify the provenance of the image data. According to some aspects of this disclosure, a user identifier encoded within the watermark may be decoded by computing device 104 and cross-referenced against a user data base to identify the user.

In 208, computing device 104 may respond to agent device 110 with a verification of the watermark. For example, computing device 104 may send agent device 110 an indication that an identification/decoding of the watermark was used to successfully verify the agent device 110, validate the provenance of the environmental data, and/or provide insight associated with any other data information associated with the agentic workflow.

In 210, agent device 110, based on verification of the watermark, may process the image data. Agent device 110 may identify and/or verify an object depicted by the image data. For example, agent device 110 may identify the user via facial recognition, object recognition, and/or the like. According to some aspects of this disclosure, agent 110 may apply any intelligence or logic to an analysis of the image data to generate the processed image data.

In 212, agent device 110 may send the processed image data to agent device 112. For example, the processed image data may identify the user as an item to track within the mechant facility and/or the like. In this example scenario, agent device 112 may be an item tracking device and image capturing device. Agent device 112 may capture an image of the user and a item they interact with (e.g., picking up a product). Agent device 112 may image data that may be combined with the processed image data (e.g., information indicative of the identity of the user, etc.) and used to generate a data record indicative of items interacted with by the user.

In 214, agent device 112 may request computing device 104 to transform the processed image data image data into a second format. For example, computing device 104 may be requested to transform the processed image data image data into the second format to generate a data record indicative of items interacted with by the user. The second format may be text-based (e.g., JavaScript Object Notation (JSON), etc.). The text-based format may be the next input to an agentic workflow. The processed image data may be sent to computing device 104 embedded with the original watermark.

In 216, computing device 104 may identify the embedded watermark. Computing device 104 may identify and/or decode the embedded watermark and map the watermark to an identifier (e.g., token, etc.) of agent device 112 to verify the provenance of the processed image data.

In 218, computing device 104 may transform the processed image data into the text-based format (e.g., JavaScript Object Notation (JSON), etc.) to generate text data and embed a watermark associated with agent device 112 into the text data. For example, the text data may include the data record indicative of items interacted with by the user. Although described in this scenario as a text-based format, in other scenarios, computing device 104 may transform processed data into any format suitable for an agentic workflow.

In 220, computing device 104 may send agent 112 the watermarked text data. For example, computing device 104 may confirm the user-item interaction and send indication of the user-item interaction with an enhanced watermark to facilitate a transaction. transaction.

In 222, agent device 112 may forward the watermarked text data to agent device 114. For example, the watermarked text data may indicate items interacted with by the user, a price for the items, and/or information indicative of a payment account or transaction instrument associated with the user. Compting device 104 may add any data information to the watermarked text data that is suitable for and/or supports the agentic workflow.

In 224, agent device 114 may process the text data as needed. For example, the text data may be processed as a final step in the agentic workflow. For example, agentr device 114 may be an intelligent point-of-sales (POS) device and/or the like. ends the watermarked text data and associated data to computing device 104 for final user identity and payment verification for items interacted with by the user.

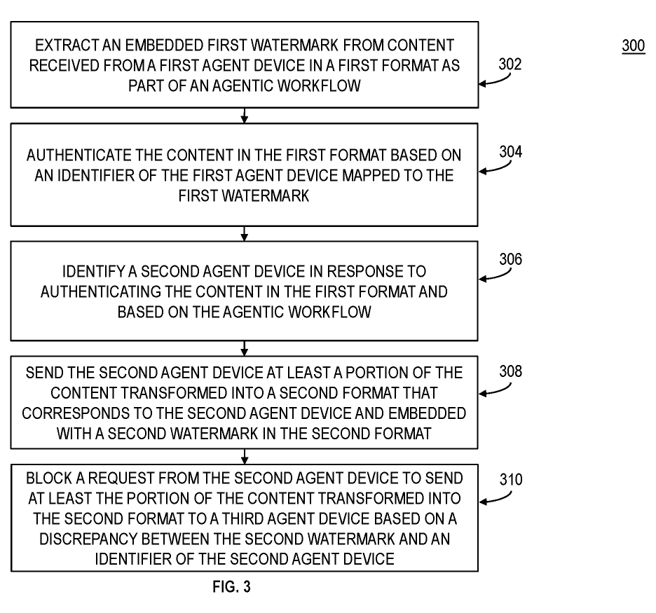

FIG. 3 shows a flowchart of an example method 300 for identity authentication in an agentic architecture, according to some aspects of this disclosure. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps maybe needed to perform the disclosure provided herein. Further, some of the steps may be performed simultaneously, or in a different order than shown in FIG. 3, as will be understood by a person of ordinary skill in the art. Method 300 shall be described with reference to FIG. 1. However, method 300 is not limited to FIG. 1 or related aspects.

In 302, computing device 110 may extract an embedded first watermark from content received from a first agent device in a first format as part of an agentic workflow. According to some aspects of this disclosure, the content received from a first agent device in the first format may be generated as an initial input to the agentic workflow.

According to some aspects of this disclosure, the first agent device may embed the first watermark. For example, computing device 110 may send an embedding instruction to the first agent device that defines a placement area and an embedding type for the first watermark to be embedded in the content in the first format.

In 304, computing device 110 may authenticate the content in the first format based on an identifier of the first agent device mapped to the first watermark.

In 306, computing device 110 identifies a second agent device in response to authenticating the content in the first format and based on the agentic workflow.

In 308, computing device 104 may send the second agent device at least a portion of the content transformed into a second format corresponding to the second agent device and embedded with a second watermark in the second format. According to some aspects of this disclosure, a location for embedding the second watermark in at least the portion of the content transformed into the second format may be identified based on a spatial property of at least the portion of the content transformed into the second format. For example, if the second format includes image data, the second watermark may be embedded in the least visually sensitive area of an image. The least sensitive areas of an image may be identified may an analysis of the spatial properties of the image to identify areas with uniform color or low contrast (e.g., the sky in a landscape or the background of an object). The second watermark may be embedded in areas with uniform color or low contrast to minimize visibility and avoid distortion in high-detail areas.

According to some aspects of this disclosure, a location for embedding the second watermark in at least the portion of the content transformed into the second format may be identified based on a frequency of at least the portion of the content transformed into the second format. For example, if the second format includes audio data, the second watermark may be embedded in the frequency domain of an audio file. Computing device 104 may use techniques include a Fourier transform and/or the like to decompose the audio data into its frequency components. Computing device 104 may identiy low-frequency bands that are less perceptible to the human ear but robust against compression. Computing device 104 may modulate these frequencies slightly to embed the second watermark without affecting the quality of the audio.

According to some aspects of this disclosure, a location for embedding the second watermark in at least the portion of the content transformed into the second format may be identified based on an amplitude of at least the portion of the content transformed into the second format. For example, if the second format includes audio data and/or video data, the second watermark may be embedded in the amplitude of an audio or video signal. For example, computing device 104 may identiy regions of the an audio or video signal where slight amplitude changes would be imperceptible (e.g., quiet background noise in audio, low-luminance regions in video, etc.). Computing device 104 may adjust the amplitude of these regions slightly to encode the second watermark while maintaining content quality.

According to some aspects of this disclosure, a location for embedding the second watermark in at least the portion of the content transformed into the second format may be identified based on a syntax property of at least the portion of the content transformed into the second format. For example, if the second format includes text data, the second watermark may be embedded in the punctuation or formatting of the text data. Computing device 104 may analyze the syntax of the text data, such as sentence structures, punctuation patterns, whitespace, and/or the like. Computing device 104 may identify locations where small, non-disruptive changes to the text data can be made. Computing device 104 may insert and/or modify punctuation (e.g., additional spaces, altering commas to semicolons) to encode the second watermark in a way that does not alter the meaning of the text data.

According to some aspects of this disclosure, a location for embedding the second watermark in at least the portion of the content transformed into the second format may be identified based on a semantic property of at least the portion of the content transformed into the second format. For example, if the second format includes text data, the second watermark may be embedded by altering synonyms or sentence structures in the text data. For example, computing device 104 may analyze the semantic properties of the text data to identify words or phrases that can be replaced with synonyms or paraphrased without changing the meaning. Computing device 104 may replace selected words or restructure sentences to embed the second watermark as a unique semantic watermark.

According to some aspects of this disclosure, a location for embedding the second watermark in at least the portion of the content transformed into the second format may be identified by computing devicee 104 based on any technique.

In 310, computing device 110 may block a request from the second agent device to send at least the portion of the content transformed into the second format to a third agent device based at least in part on a determination of whether there is a discrepancy between the second watermark and an identifier of the second agent device. For example, if computing devicee 104 finds that a registered identifier of the second agent device and an identifier of the second agent device within the second watermark do not match , computing devicee 104 may flag the occurrence as a potential security issue. The mismatch between the registered identifier of the second agent device and the identifier of the second agent device within the second watermark could indicate spoofing, tampering, or a misconfiguration. Computing device 104 may block the request and prevents the content from being forwarded the third agent device. Computing device 110 may may log the incident, send a notification to a user and/or system administrator, temporarily suspend permissions for the second agent device for a predetermined period (e.g., while the issue is investigated,etc.), and/or the like. By enforcing strict validation of watermarks and identifiers, computing device 104 may ensure/facilitate data integrity and prevent unauthorized or malicious actions within the agentic workflow.

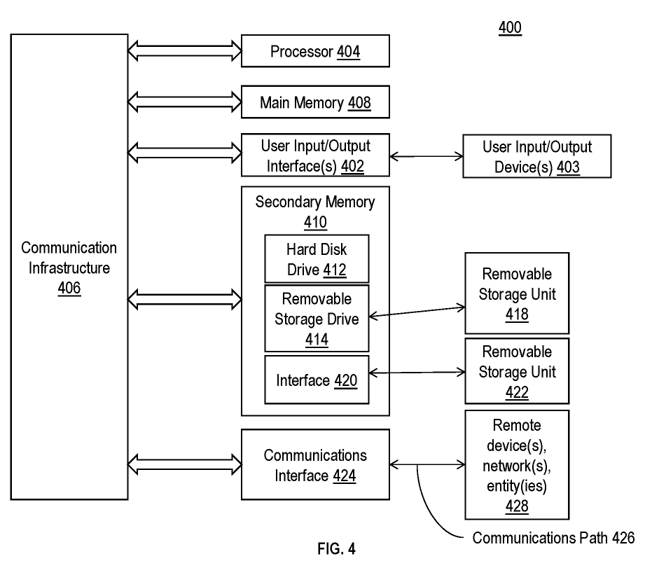

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406. In some embodiments, processor 404 may include an encryption system. This may provide transaction security and/or pass secure and/or trusted data. In some embodiments, the encryption system may be a physical secure element chip. The encryption system may also use a kernel and/or other certified software element to provide encryption and/or decryption of communications and/or messages. Such functionality may be implemented using one or more processors, such as processor 404.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/ any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smartphone, smartwatch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expressions “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method comprising:
extracting, by one or more computing devices, an embedded first watermark from content received from a first agent device in a first format as part of an agentic workflow;
authenticating the content in the first format based on an identifier of the first agent device mapped to the first watermark;
identifying, based on the agentic workflow and in response to the authenticating the content in the first format, a second agent device;
sending the second agent device at least a portion of the content transformed into a second format that corresponds to the second agent device and embedded with a second watermark in the second format; and
blocking a request from the second agent device to send at least the portion of the content transformed into the second format to a third agent device based on a discrepancy between the second watermark and an identifier of the second agent device.

2. The computer-implemented method of claim 1, wherein the second watermark is generated based on a hashing rule applied to the first watermark.

3. The computer-implemented method of claim 1, wherein the first format is different from the second format.

4. The computer-implemented method of claim 1, further comprising sending an embedding instruction to the first agent device that defines a placement area and embedding type for the first watermark to be embedded in the content in the first format by the first agent device.

5. The computer-implemented method of claim 1, wherein a location for embedding the second watermark in at least the portion of the content transformed into the second format is identified based on at least one of a spatial property of at least the portion of the content transformed into the second format or a frequency of at least the portion of the content transformed into the second format.

6. The computer-implemented method of claim 1, wherein a location for embedding the second watermark in at least the portion of the content transformed into the second format is identified based on at least one of syntax property of at least the portion of the content transformed into the second format or a semantic property of at least the portion of the content transformed into the second format.

7. The computer-implemented method of claim 1, wherein a location for embedding the second watermark in at least the portion of the content transformed into the second format is identified based on an amplitude of at least the portion of the content transformed into the second format.

8. A system, comprising:
a memory; and
at least one processor coupled to the memory and configured to perform operations comprising:
extracting an embedded first watermark from content received from a first agent device in a first format as part of an agentic workflow;
authenticating the content in the first format based on an identifier of the first agent device mapped to the first watermark;
identifying, based on the agentic workflow and in response to the authenticating the content in the first format, a second agent device;
sending the second agent device at least a portion of the content transformed into a second format that corresponds to the second agent device and embedded with a second watermark in the second format; and
blocking a request from the second agent device to send at least the portion of the content transformed into the second format to a third agent device based on a discrepency between the second watermark and an identifier of the second agent device.

9. The system of claim 1, wherein the second watermark is generated based on a hashing rule applied to the first watermark.

10. The system of claim 1, wherein the first format is different from the second format.

11. The system of claim 1, the operations further comprising sending an embedding instruction to the first agent device that defines a placement area and embedding type for the first watermark to be embedded in the content in the first format by the first agent device.

12. The system of claim 1, wherein a location for embedding the second watermark in at least the portion of the content transformed into the second format is identified based on at least one of a spatial property of at least the portion of the content transformed into the second format or a frequency of at least the portion of the content transformed into the second format.

13. The system of claim 1, wherein a location for embedding the second watermark in at least the portion of the content transformed into the second format is identified based on at least one of syntax property of at least the portion of the content transformed into the second format or a semantic property of at least the portion of the content transformed into the second format.

14. The computer-implemented method of claim 1, wherein a location for embedding the second watermark in at least the portion of the content transformed into the second format is identified based on an amplitude of at least the portion of the content transformed into the second format.

15. A non-transitory computer-readable medium having instructions stored thereon that, when executed by at least one computing device, causes the at least one computing device to perform operations comprising:
extracting an embedded first watermark from content received from a first agent device in a first format as part of an agentic workflow;
authenticating the content in the first format based on an identifier of the first agent device mapped to the first watermark;
identifying, based on the agentic workflow and in response to the authenticating the content in the first format, a second agent device;
sending the second agent device at least a portion of the content transformed into a second format that corresponds to the second agent device and embedded with a second watermark in the second format; and
blocking a request from the second agent device to send at least the portion of the content transformed into the second format to a third agent device based on a discrepency between the second watermark and an identifier of the second agent device.

16. The non-transitory computer-readable medium of claim 15, wherein the second watermark is generated based on a hashing rule applied to the first watermark.

17. The non-transitory computer-readable medium of claim 15, wherein the first format is different from the second format.

18. The non-transitory computer-readable medium of claim 15, the operations further comprising sending an embedding instruction to the first agent device that defines a placement area and embedding type for the first watermark to be embedded in the content in the first format by the first agent device.

19. The non-transitory computer-readable medium of claim 15, wherein a location for embedding the second watermark in at least the portion of the content transformed into the second format is identified based on at least one of a spatial property of at least the portion of the content transformed into the second format or a frequency of at least the portion of the content transformed into the second format.

20. The non-transitory computer-readable medium of claim 15, wherein a location for embedding the second watermark in at least the portion of the content transformed into the second format is identified based on at least one of syntax property of at least the portion of the content transformed into the second format or a semantic property of at least the portion of the content transformed into the second format.
